(19) United States
(12) Patent Application Publication
(10) Pub. No.: US 2020/0254964 A1
(43) Pub. Date: Aug. 13, 2020

(54) PRETENSIONER AND SEAT BELT APPARATUS

(71) Applicant: Joyson Safety Systems Japan K.K., Tokyo (JP)

(72) Inventors: Kazuya OKUBO, Shiga (JP); Shigeru KOHAMA, Shiga (JP)

(21) Appl. No.: 15/733,018

(22) PCT Filed: Sep. 5, 2018
(86) PCT No.: PCT/JP2018/032901

§ 371 Date: Mar. 5, 2020

(30) Foreign Application Priority Data
Sep. 15, 2017 (JP) 2017-177982

(51) Int. Cl. B60R 22/46

(52) U.S. Cl. CPC B60R 22/4619; B60R 22/4628

(57) ABSTRACT

A pretensioner includes a wire having one end connectable to webbing that restrains an occupant of a vehicle; a piston connected to another end of the wire; a cylinder that slidably accommodates the piston; a housing through which the wire passes and that holds the cylinder; and a gas generator that supplies gas to the piston through a gas chamber within the housing, the gas being for operating the piston in a retraction direction of the wire. The piston includes, at one end of a gas chamber side, a cylindrical portion that extends in an axial direction of the piston, and an initial volume of the gas chamber is adjusted by adjusting a volume of an inner space of the cylindrical portion.

### TECHNICAL FIELD

The disclosures herein relate to a pretensioner and a seat belt apparatus.

### BACKGROUND ART

A pretensioner provided in a seat belt apparatus for a vehicle has been proposed. The pretensioner retracts webbing at the time of a vehicle collision so as to improve performance of restraining an occupant by the webbing. For example, Patent Document 1 discloses a pretensioner including a wire having one end connected to webbing, a piston connected to the other end of the wire, a cylinder that slidably accommodates the piston, and a gas generator that supplies gas, for operating the piston in a retraction direction of the wire, through a gas chamber within a housing to the piston.

### RELATED-ART DOCUMENTS

### Patent Documents

[Patent Document 1] Japanese Laid-open Patent Publication No. 2013-163502

### SUMMARY OF THE INVENTION

### Problem to be Solved by the Invention

The retraction speed of the webbing by the pretensioner is determined by the pressure of the gas supplied from the gas generator to the piston. However, in the conventional pretensioner, because the gas generator mainly uses an explosive to generate the gas, the pressure of the gas is adjusted by adjusting the type and amount of the explosive. However, adjusting the type and amount of the explosive requires time and cost.

It is an object of the present disclosure to provide a pretensioner and a seat belt apparatus, in which the pressure of gas can be readily adjusted.

### Means to Solve the Problem

According to an aspect of an embodiment of the present invention, a pretensioner includes a wire having one end connectable to webbing that restrains an occupant of a vehicle; a piston connected to another end of the wire; a cylinder that slidably accommodates the piston; a housing through which the wire passes and that holds the cylinder; and a gas generator that supplies gas to the piston through a gas chamber within the housing, the gas being for operating the piston in a retraction direction of the wire. The piston includes, at one end of a gas chamber side, a cylindrical portion that extends in an axial direction of the piston, and an initial volume of the gas chamber is adjusted by adjusting a volume of an inner space of the cylindrical portion.

Similarly, according to an aspect of an embodiment of the present invention, a seat belt apparatus includes webbing that restrains an occupant of a vehicle; and the above-described pretensioner connected to the webbing and retracting the webbing at a time of a vehicle collision so as to improve performance of restraining the occupant by the webbing.

### Effects of the Invention

According to the present invention, it is possible to provide a pretensioner and a seat belt apparatus, in which the pressure of gas can be readily adjusted.

### BRIEF DESCRIPTION OF THE DRAWINGS

FIG. 1 is a diagram illustrating a configuration of a seat belt apparatus according to an embodiment of the present invention;

FIG. 2 is an exploded perspective view of a pretensioner according to an embodiment of the present invention;

FIG. 3 is a longitudinal cross-sectional view of the pretensioner;

FIG. 4 is an enlarged view of the vicinity of a gas chamber in FIG. 3;

FIG. 5 is a perspective view of a piston viewed from a housing side (negative x-side);

FIG. 6 is a cross-sectional view of a variation of the shape of an inner space of a cylindrical portion of the piston;

FIG. 7 is a diagram illustrating the action of a ball on the piston; and

FIG. 8 is a diagram illustrating the principle of locking the piston by the ball.

### MODE FOR CARRYING OUT THE INVENTION

In the following, embodiments of the present invention will be described with reference to the accompanying drawings. For convenience of explanation, the same elements are denoted by the same reference numerals in the drawings, and a duplicate description thereof will be omitted. In the following description, an x-direction, a y-direction, and a z-direction are perpendicular to each other, the x-direction and the y-direction are horizontal directions, and the z-direction is a vertical direction. The x-direction is a sliding direction of a piston 3, and a retraction direction of webbing 101 is a positive x-direction.

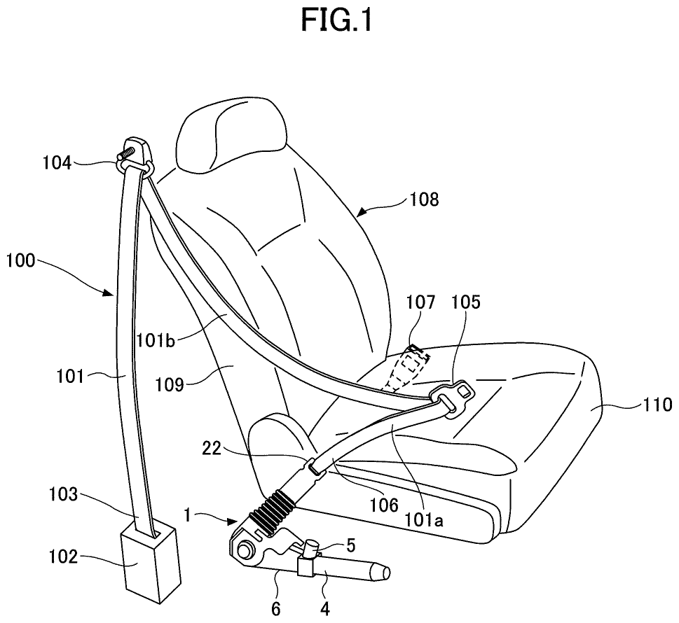

FIG. 1 is a diagram illustrating a configuration of a seat belt apparatus 100 according to an embodiment of the present invention. In FIG. 1, the seat belt apparatus 100 as mounted in a vehicle is illustrated. The seat belt apparatus 100 includes the webbing 101, a retractor 102, a tongue 105, a buckle 107, and a pretensioner 1.

The webbing 101 is a strip-shaped member for restraining an occupant in a seat. One end 103 of the webbing 101 is connected to the retractor 102, and the other end 106 of the webbing 101 is connected to the pretensioner 1.

The retractor 102 is a device that allows the webbing 101 to be retracted or extracted. When deceleration equal to or exceeding a predetermined value is detected at the time of a vehicle collision or the like, the retractor 102 restricts the webbing 101 from being pulled out of the retractor 102. The retractor 102 is fixedly mounted on the vehicle body at the side of a back 109 of the seat 108 (for example, mounted on a lower portion of a pillar on which a shoulder anchor 104 is fixedly mounted).

The tongue 105 is a plate-shaped member slidably attached to the webbing 101 between the pretensioner 1 and the shoulder anchor 104.

The buckle 107 is a member to which the tongue 105 is removably attached. The buckle 107 is fixedly mounted on the seat body on the opposite side of a seat bottom 110 of the seat 108 from the retractor 102.

With the tongue 105 attached to the buckle 107, a shoulder belt portion 101b of the webbing 101 restrains the chest of an occupant in the seat 108, and a lap belt portion 101a of the webbing 101 restrains the waist of the occupant. The shoulder belt portion 101b is a portion of the webbing 101 located between the shoulder anchor 104 and the tongue 105. The lap belt portion 101a is a portion of the webbing 101 located between the tongue 105 and the pretensioner 1.

The pretensioner 1 is a lap pretensioner that promptly retracts the lap belt portion 101a of the webbing 101 when deceleration equal to or exceeding a predetermined value is detected at the time of a vehicle collision or the like, thereby tightening up any slack in the lap belt portion 101a relative to the occupant's waist. The pretensioner 1 is typically mounted on the vehicle body towards the door with respect to a vehicle exterior side-side portion of the seat bottom 110.

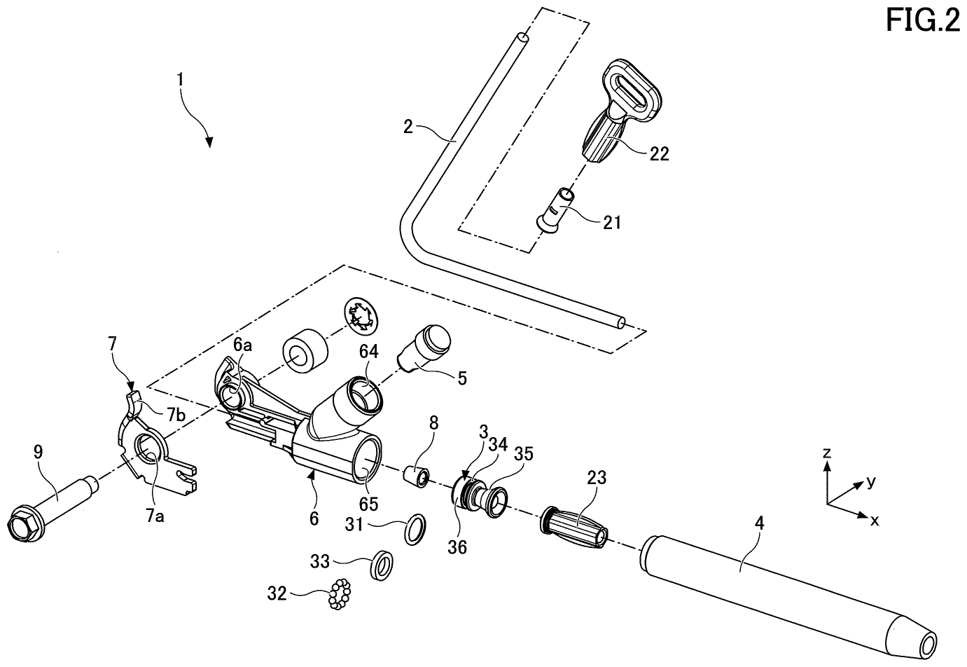

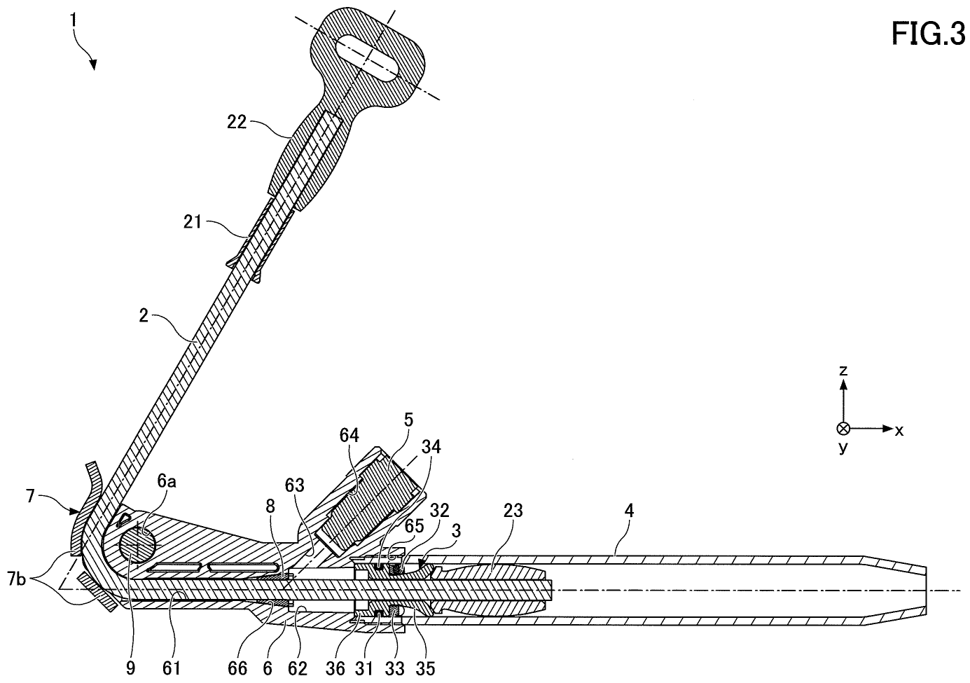

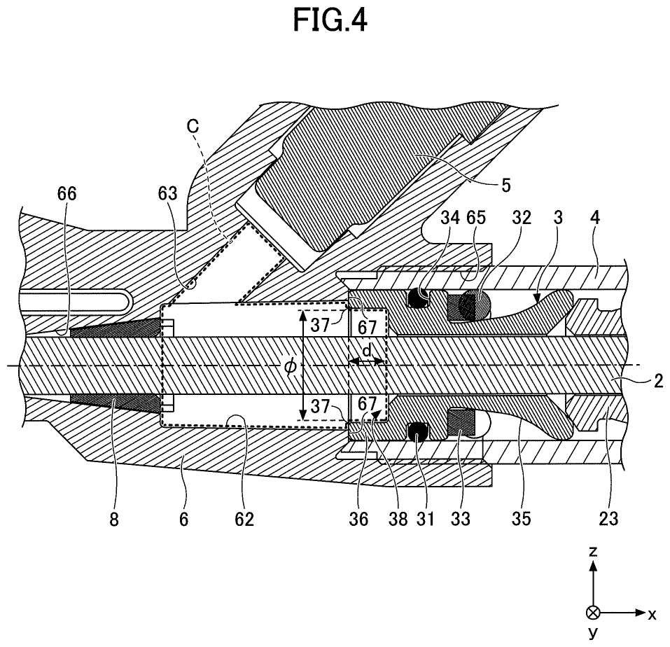

FIG. 2 is an exploded perspective view of a pretensioner 1 according to an embodiment of the present invention. FIG. 3 is a longitudinal cross-sectional view of the pretensioner 1. FIG. 4 is an enlarged view of the vicinity of a gas chamber in FIG. 3.

As illustrated in FIG. 2 and FIG. 3, the pretensioner 1 includes a wire 2 connected to the webbing 101 that restrains an occupant, the piston 3 mounted on the wire 2, a cylinder 4 that slidably accommodates the piston 3, a gas generator 5 that applies a driving force to the piston 3, a housing 6 that integrally connects the cylinder 4 and the gas generator 5, and a bracket 7 connected to the housing 6 and positioning the wire 2. The housing 6 includes an insertion hole 61 that guides the wire 2, a communication portion 62 that communicates with the cylinder 4 and the insertion hole 61, and a gas supply port 63 that supplies gas generated by the gas generator 5 to the communication portion 62. The pretensioner 1 includes a wire guide 8 provided at a boundary portion 66 between the insertion hole 61 and the communicating portion 62.

The pretensioner 1 functions as a belt anchor, and is fixed to the vehicle body by inserting a bolt 9 into a fixing hole 7a formed in the bracket 7 and into a fixing hole 6a formed in the housing 6. The bracket 7 includes a guide portion 7b. The bracket 7 retains the bending angle of the wire 2 by inserting the wire 2 along the guide portion 7b, with the bracket 7 being integrally assembled to the housing 6.

A holder 21 and a ferrule 22 are connected to one end of the wire 2. The ferrule 22 is connected to the end of the lap belt 101a of the webbing 101.

The other end of the wire 2 is inserted through the bracket 7 into the housing 6, and is connected to a wire end 23 within the cylinder 4. The piston 3 is slidably provided in the cylinder 4, and the wire 2 is connected to the wire end 23 after being inserted into the piston 3. An O-ring 31 for improving airtightness is provided on the outer circumference of the piston 3. Further, balls 32 and a ball ring 33 for preventing reverse movement of the piston 3 are provided in the middle portion of the piston 3.

As illustrated in FIG. 3 and FIG. 4, the gas generator 5 is provided in an opening (a gas-generator mounting portion 64) formed in the housing 6, and is fixed to the housing 6. A passage that connects the gas-generator mounting portion 64 and the communication portion 62 forms the gas supply port 63.

Further, the gas generator 5 is, for example, connected to a deceleration sensor (not illustrated) that detects vehicle collisions. The gas generator 5 operates upon a vehicle collision to inject high-pressure gas into the housing 6. For example, the gas generator 5 uses an explosive included in the gas generator 5 to generate gas. The high-pressure gas injected into the housing 6 presses the piston 3, and moves the piston 3 in a direction (positive x-direction) away from the housing 6. Along with the movement of the piston 3, the wire 2 is retracted into the housing 6 and the cylinder 4, and tightens the webbing 101 (lap belt 101a).

The housing 6 is, for example, formed of a material with a specific gravity lower than that of iron (such as aluminum or an aluminum alloy). Specifically, the housing 6 may be manufactured by aluminum die casting. By employing a material with a specific gravity lower than that of iron, the weight of the housing 6 can be reduced.

Further, the housing 6 includes, on one end side (negative x-side), the insertion hole 61 that guides the wire 2 from the bracket 7 to the cylinder 4, and includes, on the other end side (positive x-side), a connecting portion 65 that connects with the cylinder 4. The wire 2 is inserted into the insertion hole 61, and the connecting portion 65 is screwed with a screw portion of the cylinder 4. The communication portion 62 that communicates with the insertion hole 61 and the connecting portion 65 is formed between the insertion hole 61 and the connecting portion 65.

The inner diameter of the connecting portion 65 is larger than that of the communication portion 62. Therefore, a step is formed between the connecting portion 65 and the communication portion 62. In addition, the inner diameter of cylinder 4 is larger than that of the communication portion 62. Therefore, when the piston 3 is positioned on the negative x-side of the cylinder 4, an end face 37 on the negative x-side of the piston 3 abuts the step. As a result, further movement of the piston 3 toward the negative x-side is restricted. As illustrated in FIG. 4, the step serves as a stopper portion 67 that projects toward the center from the inner circumferential surface of the cylinder 4, thereby restricting movement of the piston 3 toward the housing 6 (negative x-side).

The inner circumferential surface on the insertion hole 61 side of the communication portion is a conical surface whose diameter decreases toward the insertion hole 61, and forms the boundary portion 66 between the insertion hole 61 and the communication portion 62. The wire guide 8 made of a resin is inserted into the boundary portion 66. The wire guide 8 has an approximately truncated cone shape, and a hole into which to insert the wire 2 is formed at the center of the wire guide 8. The wire guide 8 guides the wire 2 to the communication portion 62, and also functions to seal the boundary portion 66. An opening for communicating with the gas supply port 63 is formed on a portion of the inner circumferential surface of the communication portion 62.

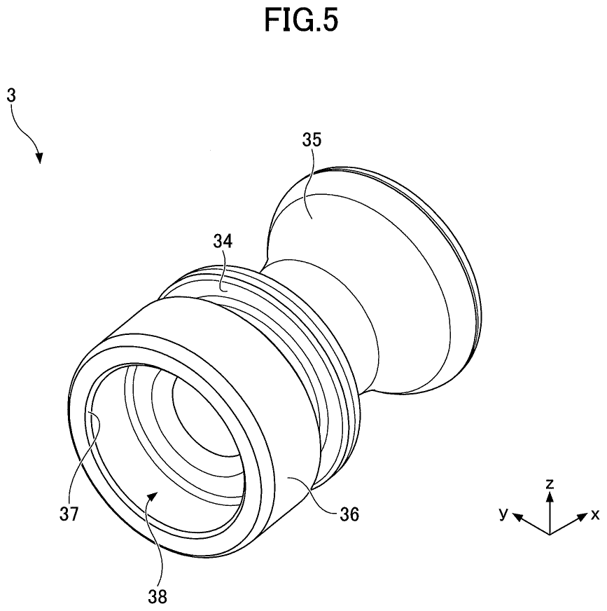

FIG. 5 is a perspective view of the piston 3 viewed from the housing 6 side (negative x-side). As illustrated in FIG. 5, a groove 34 is formed on the outer circumference of the piston 3, and the O-ring 31 is fitted to the groove 34. Further, a tapered surface 35 is formed on the outer circumference of the positive x-side of the piston 3 relative to the groove 34. The tapered surface 35 is formed such that the outer diameter of the tapered surface 35 increases from one side (negative x-side) of the piston 3, at which a cylindrical portion 36 is provided, toward the other side (positive x-side) of the piston 3.

As illustrated in FIG. 3 and FIG. 4, the balls 32 and the ball ring 33 are provided on the tapered surface 35 of the piston 3. The ball ring 33 is provided at the end of the negative x-side of the tapered surface 35, namely at a portion having the minimum outer diameter of the tapered surface 35. In a normal state, the balls 32 are biased by the ball ring 33 from the negative x-side. The balls 32 each have a diameter that does not interfere with the sliding of the piston 3 due to friction caused by contact between the balls 32 and the inner circumferential surface of the cylinder 4.

Particularly in the present embodiment, as illustrated in FIG. 2 through FIG. 5, the piston 3 includes the cylindrical portion 360 that is formed at the end of the housing 6 side (negative x-side) of the piston 3 along the outer circumferential surface, and that extends in the axial direction of the piston 3. The annular end face 37 of the cylindrical portion 36 is formed in a plane perpendicular to the axial direction of the piston 3, and makes face contact with the stopper portion 67 of the housing 6.

The cylindrical portion 36 has an inner space 38, and the inner circumferential surface of the inner space 38 extends in the axial direction of the piston 3. The cylindrical portion 36 has, at the base of the inner space 38, a hole into which the wire 2 is inserted. The inner space 38 of the cylindrical portion 36 is exposed to the communication portion 62 of the housing 6.

Accordingly, as indicated by a dotted line in FIG. 4, an internal space of the housing 6 is formed by the communication portion 62 of the housing 6, the gas supply port 63, and the inner space 38 of the cylindrical portion 36 of the piston 3. The internal space of the housing 6 may be referred to as a gas chamber. C to be filled with high-pressure gas supplied from the gas generator 5 upon the gas generator 5 being operated. The volume of the gas chamber C in a state in which the piston 3 is located at a position illustrated in FIG. 3 and FIG. 4 is referred to as the “initial volume of the gas chamber C”.

The volume of the inner space 38 of the cylindrical portion 36 can be adjusted by adjusting the inner diameter ϕ of the inner space 38 and the depth D from the end face 37 of the piston 3 to the base of the inner space 38. Accordingly, the initial volume of the gas chamber C can be adjusted.

The inner diameter ϕ of the inner space 38 is preferably smaller than the inner diameter of the stopper portion 67 of the housing 6. Accordingly, the contact area between the piston 3 and the stopper portion 67 can be maximized, thereby securely restricting movement of the piston 3 to the negative x-side.

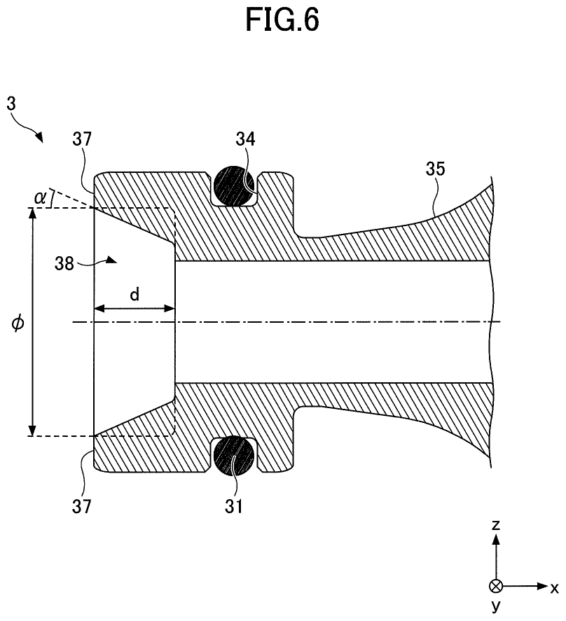

FIG. 6 is a cross-sectional view of a variation of the shape of the inner space 38 of the cylindrical portion 36 of the piston 3. As illustrated in FIG. 6, the inner circumferential surface of the inner space 38 may be a tapered surface having a predetermined taper angle α with respect to the axial direction of the piston 3. In this case, the initial volume of the inner space 38 may be adjusted by adjusting the taper angle α of the inner circumferential surface.

An effect of the pretensioner 1 according to the present embodiment will be described. The retraction speed of the webbing 101 by the pretensioner 1 is determined by the pressure of gas supplied from the gas generator 5 to the piston 3. In the conventional pretensioner, the pressure of gas is adjusted mainly by adjusting the type and amount of an explosive. However, adjusting the type and amount of an explosive requires time and cost.

The pressure of gas may also be adjusted by adjusting the volume of the gas chamber C at the time of gas generation, namely by adjusting the initial volume of the gas chamber C. However, in order to adjust the pressure of gas, if the internal shape of the housing 6 were to be changed, a variety of internal shapes would need to be produced, which would require considerable time and cost, and thus would be unrealistic.

In view of the above-described problem, in the pretensioner 1 according to the present embodiment, the piston 3 includes the cylindrical portion 36 that is formed at one end of the gas chamber C side of the piston 3 along the outer circumferential surface, and that extends in the axial direction of the piston 3. By adjusting the volume of the inner space 38 of the cylindrical portion 36, it is possible to adjust the initial volume of the gas chamber C, with the shape of the housing 6 remaining the same. Further, because the volume of the inner space 38 of the cylindrical portion 36 of the piston 3 is adjusted, the outer diameter of the piston 3 does not change. Therefore, the shape of the cylinder 4 that accommodates the piston 3 is not required to change. In order to adjust the pressure of gas, a plurality of pistons 3, whose cylindrical portions 36 have different volumes of inner spaces 38, may be applied to the existing pretensioner 1, and actual gas pressures may be checked in the plurality of pistons 3. Accordingly, in the pretensioner 1 according to the present embodiment, the pressure of gas can be readily adjusted by adjusting the volume of the inner space of the cylindrical portion 36 of the piston 3, instead of adjusting the type and amount of an explosive.

Further, in the present embodiment, the cylindrical portion 36 is formed at one end of the piston 3. Therefore, the cylindrical portion 36 can serve as a chuck margin in lathe machining. In the case of the conventional piston having no cylinder portion 36, in order to form a groove 34 and a tapered surface 35 by cutting, the conventional piston needs to be re-chucked because there is no sufficient chuck margin at the end of the groove 34 side of the conventional piston. Conversely, in the present embodiment, the cylindrical portion 36 is formed at the end of the groove 34 side of the piston 3, thereby providing a sufficient chuck margin. Accordingly, with the cylindrical portion 36 being chucked, both the groove 34 and the tapered surface 35 can be formed by cutting. As a result, re-chucking of the piston 3 is not required during machining, thus reducing machining costs.

Further, in the present embodiment, the volume of the inner space 38 of the cylindrical portion 36 is adjusted by adjusting the inner diameter (I), the depth d, or the taper angle α of the inner circumferential surface of the inner space 38. Therefore, the pressure of gas can be more readily adjusted by adjusting the size of the inner space 38 of the cylindrical portion 36 without changing the outer diameter of the piston 3.

Further, in the present embodiment, the annular end face 37 of the cylindrical portion 36 of the piston 3 is formed in a plane perpendicular to the axial direction of the piston 3. The housing 6 includes the stopper portion 67 that projects toward the center from the inner circumferential surface of the cylinder 4. In an initial state, the end face 37 of the cylindrical portion 36 of the piston 3 is disposed facing the stopper portion 67. When the wire 2 is pulled toward the webbing 101 side, the end face 37 abuts the stopper portion 67, thereby restricting movement of the piston 3 toward the housing 6 side.

In the conventional pretensioner, the end face of the gas chamber C side of the piston is a flat face, thereby increasing the contact area between the end face and a stopper portion of a housing. With the above configuration, the conventional pretensioner securely restricts movement of the piston to the negative x-side. In the piston 3 according to the present embodiment, the inside of the center of the cylindrical portion 36 is cut, while the end face 37 is left on the outer edge, thus allowing the contact area between the piston 3 and the stopper portion 67 to remain the same as that of the conventional pretensioner. Therefore, in the piston 3 according to the present embodiment, it is possible to adjust the pressure of gas and restrict movement of the piston 3 to the negative x-side, while also securing the contact area between the piston 3 and the stopper portion 67 as in the conventional pretensioner.

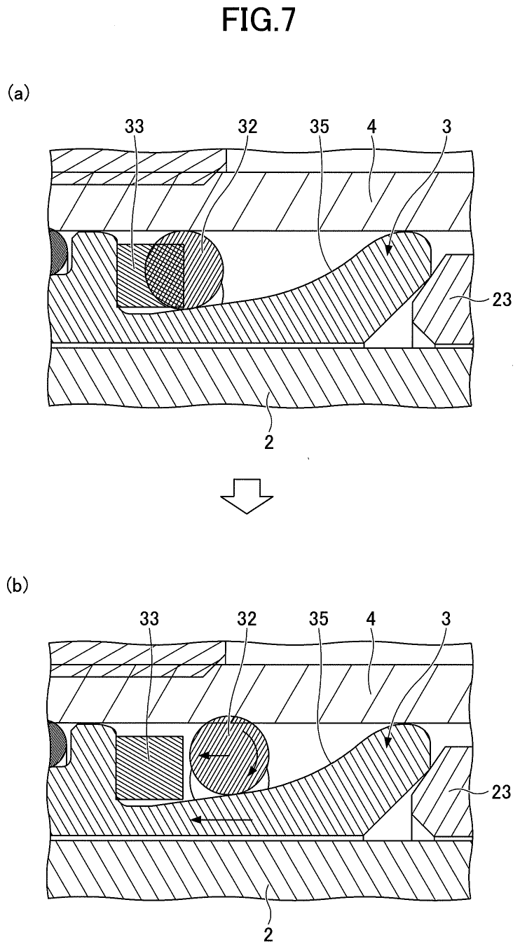

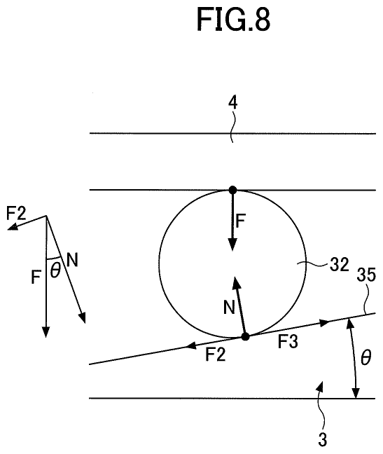

Referring to FIG. 7 and FIG. 8, an effect of a ball 32 provided on the piston 3 will be described. FIG. 7 is a diagram illustrating the action of the ball 32 on the piston 3. FIG. 8 is a diagram illustrating the principle of locking the piston 3 by the ball 32.

As illustrated in FIG. 7 (a), before the gas generator 5 is operated, the ball 32 is located at the end of the tapered surface 35 on one end side (negative x-side) of the piston 3, together with the ball ring 33, and the ball 32 is biased by the ball ring 33 from the negative x-side. As illustrated in FIG. 7 (b), the ball 32 moves to the other end side (positive x-side) of the piston 3 along the tapered surface 35, in response to the wire 2 sliding to the negative x-side and a pulling force toward the housing 6 side being exerted on the piston 3 by the wire end 23 after the gas generator 5 is operated and the piston 3 slides in the cylinder 4. A gap between the tapered surface 35 and the inner circumferential surface of the cylinder 4 decreases toward the positive x-side. Therefore, when the ball 32 has moved to the positive x-side, the ball 32 is sandwiched and fixed between the tapered surface 35 and the cylinder 4. As a result, movement of the piston 3 to the negative x-side can be restricted, and reverse movement of the piston 3 toward the housing 6 side can be prevented.

The relationship of forces exerted on the ball 32 will be further described with reference to FIG. 8. In FIG. 8, F represents a normal force exerted on the ball 32 by the inner circumferential surface of the cylinder 4, F2 represents a force that causes the ball 32 to slide down on the tapered surface 35 of the piston 3 in response to the force F, F3 represents a friction force exerted on the ball 32 by the tapered surface of the piston 3, and N represents a normal force exerted on the ball 32 by the tapered surface 35 of the piston 3.

The above-described forces can be expressed as N=F cos θ, F2=F sin θ, and F3=μN=μF cos θ, where μ is a friction coefficient and θ is the inclined angle of the tapered surface 35. When the condition F3>F2 is satisfied, the ball 32 is locked without sliding on the inner circumferential surface of the cylinder 4 and the tapered surface 35 of the piston 3.

As described above, with the configuration in which the tapered surface 35 is formed on the outer circumference of the piston 3, and the balls are provided on the tapered surface 35, it is possible to restrict movement of the piston 3 to the negative x-side, while allowing movement of the piston 3 to the positive x-side. As a result, once the pretensioner 1 is operated and the webbing 101 is retracted, the wire 2 does not return to the webbing 101 side even if a force is applied in the direction of loosening the webbing 101. Accordingly, the webbing 101 can be securely fixed.

Although specific embodiments have been described above, the present disclosure is not limited to the above-described embodiments. These described embodiments may be modified by a person skilled in the art as long as the features of the present disclosure are included. The arrangement, conditions, and shapes of the structural elements as described in the embodiments are not limited to the arrangement, conditions, and shapes as described, and may be modified as necessary. It should be noted that combination of the elements of the above-described embodiments may be changed as long as no technical contradiction occurs.

For example, unlike the above-described embodiments, the pretensioner 1 may be coupled to the buckle 107, and the buckle 107 may be instantly retracted when deceleration equal to or exceeding a predetermined value is detected at the time of a vehicle collision or the like, such that the performance of restraining an occupant by the webbing 101 can be improved.

The present application is based on and claims priority to Japanese patent application No. 2017-177982 filed on Sep. 15, 2017, with the Japanese Patent Office, the entire contents of which are hereby incorporated by reference.

### DESCRIPTION OF THE REFERENCE NUMERAL

1 pretensioner
2 wire
3 piston
32 balls
33 ball ring
35 tapered surface
36 cylindrical portion
37 end face
38 inner space
4 cylinder
5 gas generator
6 housing
67 stopper portion
100 seat belt apparatus
101 webbing
C gas chamber

1. A pretensioner comprising:
a wire having one end connectable to webbing that restrains an occupant of a vehicle;
a piston connected to another end of the wire;
a cylinder that slidably accommodates the piston;
a housing through which the wire passes and that holds the cylinder; and
a gas generator that supplies gas to the piston through a gas chamber within the housing, the gas being for operating the piston in a retraction direction of the wire,
wherein the piston includes, at one end of a gas chamber side, a cylindrical portion that extends in an axial direction of the piston, and an initial volume of the gas chamber is adjusted by adjusting a volume of an inner space of the cylindrical portion.

2. The pretensioner according to claim 1, wherein the volume of the inner space of the cylindrical portion is adjusted by adjusting an inner diameter of the inner space, a depth of the inner space, or a taper angle of an inner circumferential surface of the inner space.

3. The pretensioner according to claim 1, wherein an annular end face of the cylindrical portion is formed in a plane perpendicular to the axial direction of the piston.

4. The pretensioner according to claim 3, further comprising a stopper portion that projects toward a center from an inner circumferential surface of the cylinder, and wherein,
the end face of the cylindrical portion of the piston is disposed facing the stopper portion in an initial state, and
when the wire is pulled toward a webbing side, the end face abuts the stopper portion so as to restrict movement of the piston toward a housing side.

5. The pretensioner according to claim 1, wherein the piston includes
a tapered surface formed on an outer circumference of the piston, and having an outer diameter that increases from one end side to another end side of the piston,
a ball ring provided at an end of the tapered surface on the one end side, and a ball provided on the tapered surface and biased by the ball ring,
wherein the ball moves to the another end side of the piston along the tapered surface, in response to a pulling force toward a housing side being exerted on the piston by the wire after the gas generator is operated and the piston slides in the cylinder, and
the ball is sandwiched and fixed between an inner circumferential surface of the cylinder and the tapered surface of the piston, so as to fix the piston.

6. A seat belt apparatus comprising:
webbing that restrains an occupant of a vehicle; and
the pretensioner according to claim 1, the pretensioner being connected to the webbing, and retracting the webbing at a time of a vehicle collision so as to improve performance of restraining the occupant by the webbing.
